(19) United States
(12) Patent Application Publication
(10) Pub. No.: US 2024/0369341 A1
(43) Pub. Date: Nov. 7, 2024

(54) MEASURING ARM FOR A COORDINATE MEASURING MACHINE AND COORDINATE MEASURING MACHINE

(71) Applicant: Klingelnberg GmbH, Hückeswagen (DE)

(72) Inventors: Laura Ackerschott, Wipperfürth (DE); Matthias Daniels, Bergisch Gladbach (DE); Johann Bergen, Bergneustadt (DE); Harald Wüster, Radevormwald (DE); Robin Weber, Hückeswagen (DE)

(21) Appl. No.: 18/653,541

(22) Filed: May 2, 2024

(30) Foreign Application Priority Data
May 2, 2023 (EP) 23170989.0

(51) Int. Cl. G01B 5/008

(52) U.S. Cl. CPC G01B 5/008

(57) ABSTRACT

A measuring arm for a coordinate measuring machine, having a support structure, wherein the support structure includes a fastening section for fastening the measuring arm on a movable slide of the coordinate measuring machine, having a measuring head for acquiring measured values on a component to be measured. The measuring head is mounted on the support structure, and the support structure includes an auxiliary mass damper for oscillation damping.

### CROSS-REFERENCE TO RELATED APPLICATIONS

This application claims the benefit of European patent application no. 23170989.0, filed on 2 May 2023, the disclosure of which is incorporated herein by reference in its entirety.

### TECHNICAL FIELD

The present disclosure relates to a measuring arm for a coordinate measuring machine, having a support structure, wherein the support structure has a fastening section for fastening the measuring arm on a movable slide of the coordinate measuring machine and having a measuring head for acquiring measured values on a component to be measured, wherein the measuring head is mounted on the support structure. Furthermore, the disclosure relates to a coordinate measuring machine having such a measuring arm.

### BACKGROUND

Coordinate measuring machines are used for measuring components in order to check the quality of a manufactured component. In this case, for example, it is checked whether specified manufacturing tolerances have been maintained. Moreover, corrections for a manufacturing process can be determined on the basis of measured component deviations. The derivation of corrected manufacturing parameters on the basis of component deviations is also referred to as a quality control loop.

Coordinate measuring machines have numerically controlled, driven axes in order to execute relative movements during the measurement of a component between the measuring head of the coordinate measuring machine, which is mounted on the measuring arm and which acquires measured values on the component, and the component to be measured.

The measuring arm is therefore moved during the measurement in order to position the measuring head along a specified measurement path or to record specified measurement points relative to the component. Such a measuring arm has one or more eigenmodes having the corresponding associated natural frequencies, so that oscillations of the measuring arm can occur due to the movement of the measuring arm, which can corrupt the measurement result or can delay the measurement.

The problem of the oscillations of a measuring arm increasingly occurs during the measurement of particularly large gear wheels, for example, as are used in wind power, for example. To be able to measure such gear wheels, and in particular measure internal features of such gear wheels, such as bearing points or internal teeth of inner gear teeth, measuring arms projecting a long distance are used. A great distance is formed here between the drive or the mounting of the measuring arm and the measurement point in the area of the measuring head. It is obvious that such a design is more sensitive with respect to the influence of oscillations due to the large distance or lever to the measurement point and tends more toward oscillations than a design which manages without a projecting measuring arm and positions the measuring head in direct proximity to the mounting or to the driven axes.

FIG. 1 shows an example in this regard of a coordinate measuring machine 200 having a turntable 210 for accommodating the work piece, having three driven linear axes in the direction x, y, z and having a measuring head 220, which is mounted directly on the linear axes, i.e., without a measuring arm projecting a long distance on the coordinate measuring machine 200. FIG. 2 shows in comparison thereto a coordinate measuring machine 300 having a measuring arm 310 which projects a long distance and can be extended a long distance and which tends to oscillate as mentioned above.

In principle, it is possible to counter the above-described problems of oscillation excitation as a result of the movement of the axes of a coordinate measuring machine by reinforcing the measuring arm or by adapting the speed of the relative movements. However, reinforcing the measuring arm results in a higher weight thereof, so that the corresponding associated drives and mounts possibly also have to be dimensioned larger and more rigid. An adaptation of the speed of the relative movements, i.e., in particular reducing the axis accelerations and axis velocities and possibly maintaining waiting times for the decay of the oscillation leads to an increase of the measurement time, which results in a less efficient measuring process. Both above-mentioned variants are therefore disadvantageous and result overall in higher costs on the customer side.

### SUMMARY

Against this background, the present disclosure is based on the technical problem of specifying and improved measuring arm, which in particular enables more reliable measurement of larger components, in particular reliable measurement of internal features of rotationally symmetrical components, such as inner gear teeth or the like. Furthermore, a coordinate measuring machine having such a measuring arm is to be specified.

The above-described technical problem is solved by the features of the independent claims. Further embodiments of the disclosure result from the dependent claims and the following description.

According to a first aspect, the disclosure relates to a measuring arm for a coordinate measuring machine having a support structure, wherein the support structure has a fastening section for fastening the measuring arm on a movable slide of the coordinate measuring machine, having a measuring head for acquiring measured values on a component to be measured, wherein the measuring head is mounted on the support structure. The measuring arm is distinguished in that the support structure of the measuring arm has an auxiliary mass damper for oscillation damping.

Studies of the applicant have shown that a very efficient solution for eliminating the oscillation problem described at the outset is the integration of an auxiliary mass damper in the measuring arm. In this way, oscillations can be reduced or damped without negative effects occurring with respect to the possible measuring speeds or a significant increase of the weight of the measuring arm as a whole occurring.

The support structure of the measuring arm can comprise a steel material, for example. The use of steel has the advantage that a robust and rigid construction of the measuring arm can be achieved. Alternatively or additionally, it can be provided that the measuring arm comprises a metallic material which has a lower weight than steel, and/or that the measuring arm comprises a composite material, in particular comprises a fiber composite material.

The measuring head can comprise a tactile measuring probe, such as a switching measuring probe, a scanning measuring probe, or the like. In this case, the tactile measuring probe comprises, for example, a ball tip, which is configured to be brought into contact with a component to be measured in order to record one or more measured values.

Alternatively or additionally, it can be provided that the measuring head comprises an optical measuring probe, wherein such an optical measuring probe can also be referred to as an optical distance sensor. Such an optical measuring probe is configured to acquire measured values without contact on the component. It can be provided that the optical distance sensor is a point sensor and operates according to one of the following measurement principles: laser triangulation, confocal or confocal-chromatic distance measurement, interferometric distance measurement, double frequency comb spectroscopy, or the like.

It can be provided that the measuring head is fastened on the auxiliary mass damper of the support structure. In this way, the damping effect of the auxiliary mass damper can unfold in the immediate vicinity of the measuring head, so that oscillations can be damped in the area of the measuring head in order to enable a rapid measured value acquisition which is as precise as possible.

The measuring head can, for example, be detachably fastened on the auxiliary mass damper. For example, the measuring head can be screwed to the auxiliary mass damper, so that, for example, one screw connection or two or more screw connections are provided in order to fasten the measuring head on the auxiliary mass damper. It is obvious that, according to alternative exemplary embodiments, the measuring head can also be connected to the auxiliary mass damper by other detachable fastening means or types of fastening, such as clamp connections, catch connections, pin connections, or the like.

Alternatively, it can be provided that the measuring head is permanently connected to the auxiliary mass damper. For example, the measuring head can be connected to the auxiliary mass damper by means of an adhesive bond or by means of a material bond, such as a welded bond, a soldered bond, or the like. In the present case, mechanical connections which are not detachable nondestructively, such as rivet connections or the like, are also considered to be permanent connections.

According to one embodiment of the measuring arm, it can be provided that the support structure comprises bar elements, which are connected to one another at the ends, and the longitudinal axes of which enclose an angle in relation to one another, in particular enclose a right angle in relation to one another.

The bar elements can be oblong bar elements, the length of which measured along the respective longitudinal axis corresponds to a multiple of a thickness measured perpendicular to the longitudinal axis. In particular, a respective length of a respective bar element measured along the longitudinal axis corresponds to at least three times the thickness of the respective bar element measured perpendicular to the longitudinal axis, in particular at least four times or at least five times the thickness of the respective bar element measured perpendicular to the longitudinal axis.

For example, it can be provided that the support structure comprises precisely two bar elements or that the support structure comprises precisely three bar elements.

According to one embodiment of the measuring arm, it can be provided that the auxiliary mass damper is fastened to an end section of a bar element of the support structure.

In particular, it can be provided that the auxiliary mass damper is detachably fastened to one of the bar elements of the support structure, in particular screwed on. Alternatively, it can be provided that the auxiliary mass damper is permanently connected to one of the bar elements of the support structure. Reference is made to the preceding statements on the fastening of the measuring head with respect to the definitions of a detachable connection and a permanent connection.

According to one embodiment of the measuring arm, it can be provided that the auxiliary mass damper is arranged between the end section of the bar element and the measuring head. A compact integration of the auxiliary mass damper into the measuring arm can thus take place.

It can be provided that a thickness of the auxiliary mass damper measured perpendicular to the longitudinal extension of the associated bar element is less than or equal to the thickness of the relevant bar element, also measured transversely to the longitudinal extension, or a cross-sectional area of the auxiliary mass damper is less than or equal to a cross-sectional area of the associated bar element, on which the auxiliary mass damper is fastened. In this way, a compact integration of the auxiliary mass damper into the support structure can take place, so that the bar element having the auxiliary mass damper fastened thereon can be jointly covered. In other words, the auxiliary mass damper can be incorporated into an existing construction of a measuring arm without enlarging the dimensions of the relevant measuring arm viewed transversely to the longitudinal extension of the bar element. This has the advantage that no additional collision structure arises due to the auxiliary mass damper integrated into the support structure, which would have to be taken into consideration during relative travel movements of a coordinate measuring machine. The measuring arm according to the disclosure can therefore be operated in the same manner as a measuring arm without integrated damping element in the form of an auxiliary mass damper.

According to one embodiment of the measuring arm, three bar elements can be provided which form a U-shaped arrangement. The U-shaped arrangement in particular enables the measurement of internal features of large gear wheels, for example, having an internal diameter greater than or equal to 1000 mm and/or a modulus greater than 8 mm. In this case, the measuring head can be positioned in the area of a passage opening of the gear wheel to be measured, while a part of the gear wheel projects between the legs of the U-shaped measuring arm, and a collision of the measuring arm with the gear wheel during the measurement can thus be avoided.

The fastening section can be formed on a first freely projecting end section of the U-shaped arrangement and the measuring head can be arranged on a second freely projecting end section of the U-shaped arrangement.

According to one embodiment of the measuring arm, it can be provided that the auxiliary mass damper is active in two spatial directions orthogonal to one another or that the auxiliary mass damper is active in three spatial directions orthogonal to one another. The auxiliary mass damper can therefore be aligned such that its damping effect is unfolded in particular depending on the direction in specified spatial directions. Targeted damping of specific undesired oscillations can thus be achieved.

According to one embodiment of the measuring arm, it can be provided that the auxiliary mass damper comprises a housing, that at least one mass element, which is fastened to the housing using springs, is arranged inside the housing, and that the auxiliary mass damper is filled with an oil. In particular, the mass element is directly in contact with the oil, wherein a movement of the mass element is damped by the oil. In particular, a gap between the mass element and the housing is filled with the oil so that an oil layer is formed in the gap, wherein the movement of the mass element causes a shear of the oil layer, which results in speed-proportional damping. The mass element is therefore in particular an oscillating mass, wherein the mass element is furthermore in particular fastened on the housing exclusively by the springs.

The mass element can have a weight of 1 kg or more, in particular a weight of 5 kg or more. The mass element can have a weight of 20 kg or less, in particular a weight of 10 kg or less.

It can be provided that the auxiliary mass damper comprises two or more further mass elements. In particular, it can be provided that each of the two or more further mass elements is connected in a springy manner to the housing in the above-described manner and is in damping-active contact with the oil.

It can be provided that one or more intermediate elements, which transfer a movement of the mass element to the oil, such as a membrane or the like, are provided between a respective mass element and the oil.

In particular, it is provided that the mass element or, if multiple mass elements are provided, each of the mass elements is directly in contact with the oil and no intermediate element is provided between a respective mass element and the oil.

The springs can be arranged on sides of the mass element facing away from one another, wherein in particular two or more springs are provided per spatial direction and the springs are arranged in particular in a parallel circuit. The two-sided fastening of the mass elements by means of the springs is a suspension of the mass elements within the housing. The mass element can therefore freely oscillate within the specified boundaries of the housing and the respective possible spring travels.

The orientation or alignment of the corresponding springs along specified spatial directions enables a definition of the oscillation and damping behavior of the auxiliary mass damper along the corresponding spatial directions, in that a respective specified number of the relevant springs are used, each having a respective specified stiffness.

The use of different springs and/or a different number of springs per spatial direction therefore enables a direction-specific setting of the damping behavior. For example, tension springs and/or compression springs can be used.

It can be provided that the auxiliary mass damper has a first stiffness and/or a first damping in a first damping direction, that the auxiliary mass damper has a second stiffness and/or a second damping in a second damping direction, and that the first stiffness is different from the second stiffness and/or that the first damping is different from the second damping.

According to one embodiment of the auxiliary mass damper, it can be provided that the first stiffness has been defined in consideration of a first eigenmode determined on the undamped measuring arm and that the second stiffness has been defined in consideration of a second eigenmode determined on the undamped measuring arm. For this purpose, for example, an experimental and/or a computer-assisted simulated modal analysis may have been carried out, in order to determine the eigenmodes of the undamped measuring arm and the associated natural frequencies and oscillation forms.

According to the disclosure, a coordinate measuring machine is specified, having a turntable for receiving a workpiece, wherein the turntable comprises an axis of rotation for rotating the workpiece, having a measuring arm, wherein the measuring arm is designed according to the disclosure and having three linear axes for the translational displacement of the measuring arm relative to the workpiece. The coordinate measuring machine according to the disclosure in particular enables efficient and precise measurement even of large components, since the auxiliary mass damper of the support structure of the measuring arm reduces oscillations in the area of the measuring head.

According to one embodiment of the coordinate measuring machine, it can be provided that the auxiliary mass damper is active in three spatial directions orthogonal to one another, that a first linear axis of the three linear axes is configured for the translational displacement of the measuring arm in a first spatial direction, that a second linear axis of the three linear axes is configured for the translational displacement of the measuring arm in a second spatial direction, and that a third linear axis of the three linear axes is configured for the translational displacement of the measuring arm in a third spatial direction, wherein the first, the second, and the third spatial directions are each oriented orthogonal to one another, and that the first, second, and third spatial directions are oriented colinear to the three spatial directions of the activity of the auxiliary mass damper, which are orthogonal to one another. The activity of the auxiliary mass damper is therefore oriented along the movement directions of the linear axes of the coordinate measuring machine. Oscillations which result due to the axial accelerations of the linear axes can thus be deliberately damped depending on direction.

According to alternative embodiments, it can be provided that the auxiliary mass damper has precisely one direction of action or that the auxiliary mass damper has precisely two directions of action. The auxiliary mass damper can therefore be adapted to the relevant measuring arm.

### BRIEF DESCRIPTION OF THE DRAWINGS

The disclosure will be described in more detail hereinafter on the basis of a drawing showing exemplary embodiments. In the schematic figures:

FIG. 1 shows a coordinate measuring machine according to the prior art;

FIG. 2 shows a coordinate measuring machine having a projecting measuring arm according to the prior art;

FIG. 3 shows a measuring arm according to the disclosure;

FIG. 4 shows an auxiliary mass damper; and

FIG. 5 shows a coordinate measuring machine according to the disclosure.

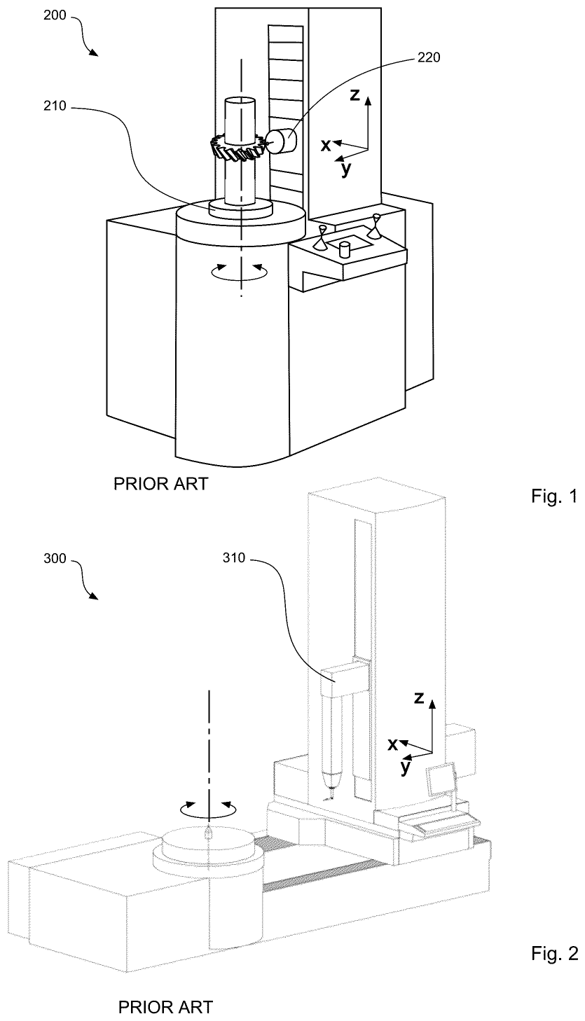

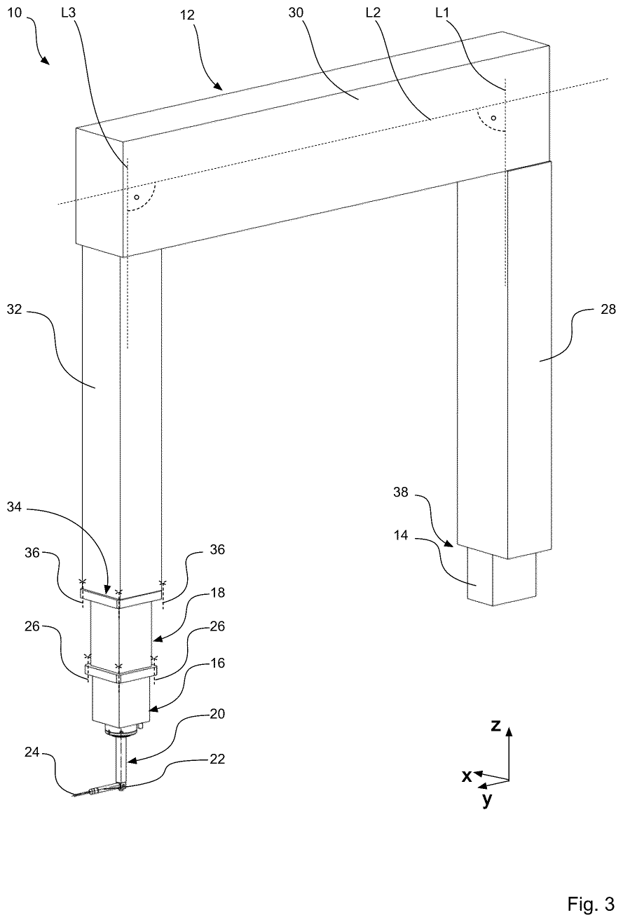

### DETAILED DESCRIPTION OF THE DRAWINGS

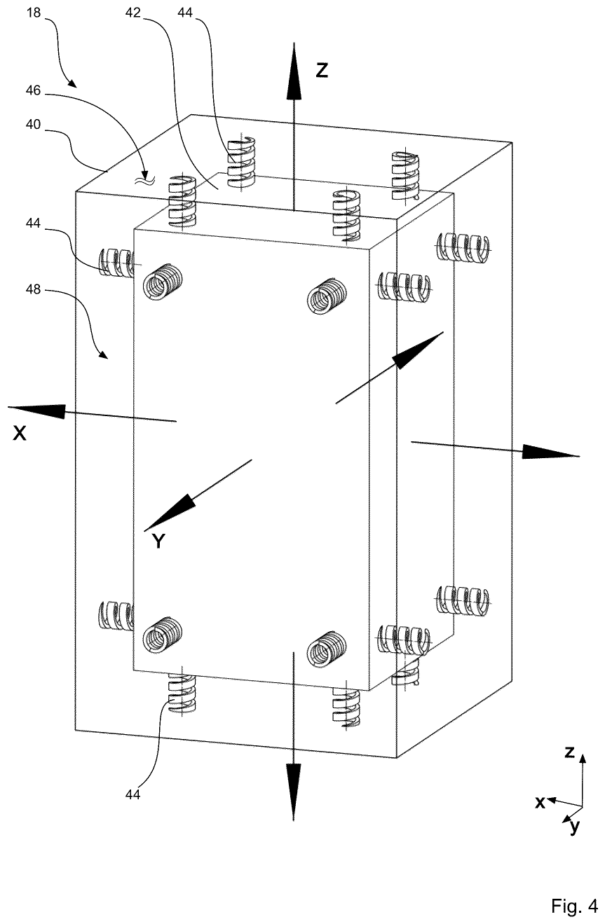

FIG. 3 shows a measuring arm 10 according to the disclosure for a coordinate measuring machine.

The measuring arm 10 has a support structure 12. The support structure 12 comprises a fastening section 14 for fastening the measuring arm 10 on a movable slide of the coordinate measuring machine.

The measuring arm 10 has a measuring head 16 for acquiring measured values on a component to be measured. The measuring head 16 is mounted on the support structure 12.

The support structure 12 comprises an auxiliary mass damper 18 for oscillation damping.

The measuring head 16 comprises a tactile measuring probe 20, which has a pin tip 22 having a ball tip 24 fastened on the end thereof. The ball tip 24 is provided to be brought into contact with a component to be measured in order to acquire measured values in this way. The use of such a tactile measuring probe 20 having a corresponding ball tip 24 is prior art in the area of coordinate measuring technology. The measuring probe 20 is mounted removably and exchangeably on the measuring head 16.

The measuring head 16 is fastened on the auxiliary mass damper 18 of the support structure 12. In the present case, the measuring head 16 is detachably and exchangeably fastened on the auxiliary mass damper 18—specifically by means of screw connections 26, which are solely schematically indicated.

The support structure 12 comprises three bar elements 28, 30, 32. The bar elements 28, 30, 32 are connected to one another at the ends. Specifically, the bar element 28 is connected at the end to the bar element 30 and the bar element 30 is connected at the end to the bar element 32. The longitudinal axes L1 and L2 of the bar elements 28 and 30 enclose a right angle in relation to one another. The longitudinal axes L2 and L3 of the bar elements 30, 32 enclose a right angle in relation to one another.

The longitudinal axis L1 is oriented parallel to the z axis. The longitudinal axis L2 is oriented parallel to the y axis. The longitudinal axis L3 is oriented parallel to the z axis.

The auxiliary mass damper 18 is fastened on an end section 34 of the bar element 32 of the support structure 12. In the present case, the auxiliary mass damper 28 is detachably connected to the bar element 32 of the support structure-specifically by means of screw connections 36, which are again only schematically indicated.

The auxiliary mass damper 18 is arranged in the present case between the end section 34 of the bar element 32 and the measuring head 16.

In the present case, the three bar elements 28, 30, 32 form a U-shaped arrangement. The fastening section 14 is arranged in this case on a first freely projecting end section 38 of the U-shaped arrangement. The measuring head 16 is formed on a second freely projecting end section of the U-shaped arrangement, wherein the second freely projecting end section is formed in the present case by the auxiliary mass damper 18.

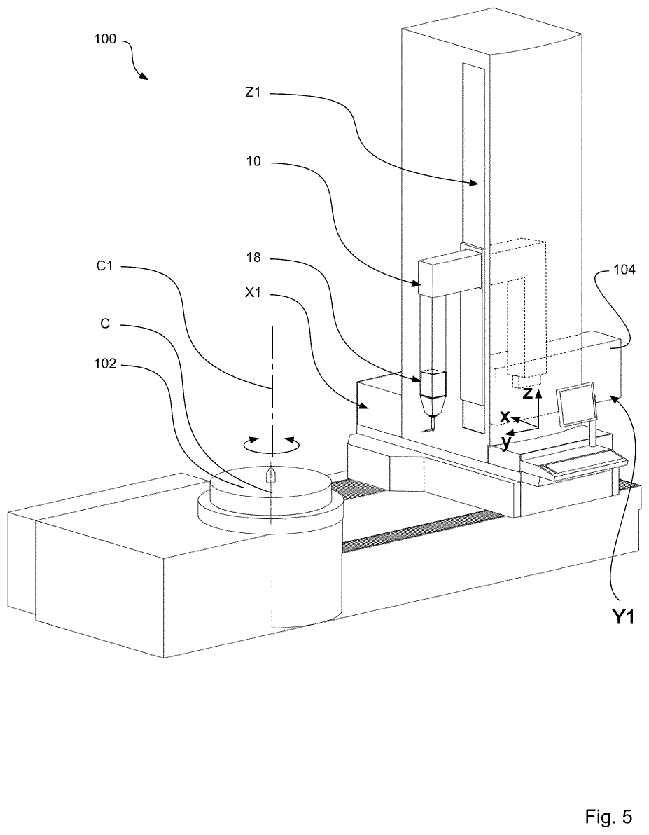

FIG. 4 shows the auxiliary mass damper 18 in a schematic representation. The auxiliary mass damper is active in the present case in three spatial directions X, Y, Z orthogonal to one another, wherein the spatial directions X, Y, Z are oriented collinear to the axes of the coordinate system x, y, z shown. To illustrate that the auxiliary mass damper 18 is obviously also active in the negative direction of the corresponding spatial directions X, Y, Z orthogonal to one another, additional directional arrows have been shown in each case in the corresponding opposite direction.

The auxiliary mass damper 18 comprises a housing 40. A mass element 42 is arranged inside the housing 40. The mass element 42 is an oscillating mass which is mounted removably in each of the three above-mentioned spatial directions X, Y, Z inside the housing 40.

The mass element 42 is fastened by means of springs 44 on the housing 40.

The springs 44 are each arranged on sides of the mass element 42 facing away from one another, so that the mass element 42 is supported in a spring-elastic manner against the housing 40 in each possible movement direction.

A plurality of springs 44 are provided for each spatial direction X, Y, Z, which are arranged in a parallel circuit viewed for each side.

The rigidity of the auxiliary mass damper can differ depending on the spatial direction X, Y, Z. This can be defined by the number of the springs or the dimension or type of the selected springs.

In the present case, the rigidities of the auxiliary mass damper 18 have been defined in consideration of determined eigenmodes.

The housing 40 of the auxiliary mass damper 18 is filled with an oil 46. The oil 46 fills a gap 48 formed between the mass element 42 and the housing 40, so that a movement of the mass element 42 relative to the housing 40 in one of the directions X, Y, Z causes a shear of the oil 46 and an accompanying speed-proportional damping.

FIG. 5 shows a coordinate measuring machine 100 according to the disclosure. The coordinate measuring machine 100 has a turntable 102 for accommodating a component or workpiece to be measured, such as an internally-toothed gear wheel or the like.

The turntable 102 has a CNC-controlled axis of rotation C1 or rotational axis C1 for rotating the workpiece to be measured around its own axis C. The workpiece can be, for example, a rotationally-symmetrical component, such as an internally-toothed gear wheel or the like.

The coordinate measuring machine 100 has a measuring arm 10 according to the disclosure, which comprises the auxiliary mass damper 18.

The coordinate measuring machine 100 moreover has three linear axes X1, Y1, Z1 for translational displacement of the measuring arm 10 relative to the workpiece along the orthogonal spatial directions x, y, z, wherein x, y, z form a Cartesian coordinate system.

A first linear axis X1 of the three linear axes X1, Y1, Z1 is configured for translational displacement of the measuring arm in a first spatial direction x of the orthogonal spatial directions x, y, z. A second linear axis Y1 of the three linear axes X1, Y1, Z1 is configured for translational displacement of the measuring arm in a second spatial direction y of the orthogonal spatial directions x, y, z. A third linear axis Z1 of the three linear axes X1, Y1, Z1 is configured for translational displacement of the measuring arm in a third spatial direction z of the orthogonal spatial directions x, y, z.

The first, second, and third spatial direction x, y, z are oriented colinear to the three spatial directions X, Y, Z, which orthogonal to one another, of the activity of the auxiliary mass damper 18.

FIG. 5 schematically indicates that the measuring arm 10 is fastened with its fastening section 14 on a slide 104, movable in the y direction, of the coordinate measuring machine 100.

1-11. (canceled)

12. A coordinate measuring machine, comprising:
a turntable for accommodating a workpiece, wherein the turntable has an axis of rotation for rotating the workpiece,
a measuring arm,
the measuring arm having a support structure, wherein the support structure comprises a fastening section for fastening the measuring arm on a movable slide of the coordinate measuring machine,
the measuring arm having a measuring head for acquiring measured values on a component to be measured, wherein the measuring head is mounted on the support structure,
wherein the support structure comprises an auxiliary mass damper for oscillation damping
wherein the support structure (12) comprises bar elements (28, 30, 32), which are connected to one another at the ends, and the longitudinal axes (L1, L2, L3) thereof enclose an angle in relation to one another and
having three linear axes for translational displacement of the measuring arm relative to the workpiece.

13. The coordinate measuring machine as claimed in claim 12,
wherein
the measuring head is fastened on the auxiliary mass damper of the support structure.

14. The coordinate measuring machine as claimed in claim 12,
wherein the bar elements enclose a right angle in relation to one another, wherein the support structure has precisely two bar elements or precisely three bar elements.

15. The coordinate measuring machine as claimed in claim 14,
wherein the auxiliary mass damper is fastened on an end section of a bar element of the support structure.

16. The measuring arm as claimed in claim 13,
wherein the auxiliary mass damper is arranged between the end section of the bar element and the measuring head.

17. The coordinate measuring machine as claimed in claim 14, wherein
three bar elements are provided, which form a U-shaped arrangement,
wherein the fastening section is formed on a first freely projecting end section of the U-shaped arrangement, and
wherein the measuring head is arranged on a second freely projecting end section of the U-shaped arrangement.

18. The coordinate measuring machine as claimed in claim 12, wherein
the auxiliary mass damper is active in two spatial directions orthogonal to one another or
the auxiliary mass damper is active in three spatial directions orthogonal to one another,
a first linear axis of the three linear axes is configured for the translational displacement of the measuring arm in a first spatial direction,
a second linear axis of the three linear axes is configured for the translational displacement of the measuring arm in a second spatial direction, and
a third linear axis of the three linear axes is configured for the translational displacement of the measuring arm in a third spatial direction,
wherein the first, the second, and the third spatial directions are each oriented orthogonal to one another and
the first, second, and third spatial directions are oriented colinear to the three spatial directions, which are orthogonal to one another, of the activity of the auxiliary mass damper.

19. The coordinate measuring machine as claimed in claim 12, wherein
the auxiliary mass damper comprises a housing,
at least one mass element, which is fastened on the housing using springs, is arranged inside the housing, and
the auxiliary mass damper is filled with an oil.

20. The coordinate measuring machine as claimed in claim 18, wherein
the springs are arranged on sides of the mass element facing away from one another,
wherein two or more springs are provided per spatial direction and the springs are arranged in a parallel circuit.

21. The coordinate measuring machine as claimed in claim 18, wherein
the auxiliary mass damper has a first rigidity and/or first damping in a first damping direction,
the auxiliary mass damper has a second rigidity and/or a second damping in a second damping direction, and
the first rigidity is different from the second rigidity and/or the first damping is different from the second damping.

22. The coordinate measuring machine as claimed in claim 21, wherein
the first rigidity has been defined in consideration of a first eigenmode determined on the undamped measuring arm and
the second rigidity has been defined in consideration of a second eigenmode determined on the undamped measuring arm.
